(19) United States
(12) Patent Application Publication
(10) Pub. No.: US 2025/0355281 A1
(43) Pub. Date: Nov. 20, 2025

(54) SMART CONTACT LENS AND METHOD OF FABRICATING THE SAME

(71) Applicant: PEGAVISION CORPORATION, TAOYUAN CITY (TW)

(72) Inventors: Te-Sheng YANG, TAOYUAN CITY (TW); Han-Yi CHANG, TAOYUAN CITY (TW); Yi-Fang HUANG, TAOYUAN CITY (TW); Yu-Yen CHIANG, TAOYUAN CITY (TW)

(21) Appl. No.: 19/212,705

(22) Filed: May 20, 2025

Related U.S. Application Data
(60) Provisional application No. 63/649,925, filed on May 20, 2024.
(60) Provisional application No. 63/754,592, filed on Feb. 6, 2025.

(51) Int. Cl. G02C 7/10; G02C 7/04

(52) U.S. Cl. CPC G02C 7/101; G02C 7/04

(57) ABSTRACT

A smart contact lens includes a lens body, a circuit structure, and a control chip. The lens body has an optical portion and an annular wearing portion surrounding the optical portion. The circuit structure and the control chip are disposed at the annular wearing portion. The smart contact lens further includes a light-adjusting component or a pattern displaying component disposed at the optical portion, in which the light-adjusting component is configured to provide sunglasses function, and the pattern displaying component is configured to provide beauty function. Each of the light-adjusting component and the pattern displaying component includes a liquid crystal layer to adjust light transmittance and/or color performance, with the advantages of low power consume and low thermal generation.

### CROSS-REFERENCE TO RELATED APPLICATION

This application claims priority to U.S. Provisional Application Ser. No. 63/649,925, filed May 20, 2024 and U.S. Provisional Application Ser. No. 63/754,592, filed Feb. 6, 2025, which are herein incorporated by reference in their entireties.

### BACKGROUND

### Field of Invention

The present disclosure relates to a smart contact lens and method of fabricating the same.

### Description of Related Art

With the popular demand of contact lens, the comfortability, moisture, oxygen permeability, and function of the contact lens become more and more important. For example, the contact lens provides not only refractive error correction and/or makeup function, but also provides different optical variations in response to different using environments.

Therefore, there is a need to provide a smart contact lens.

### SUMMARY

An aspect of the disclosure provides a smart contact lens. The smart contact lens includes a lens body including an optical portion and an annular wearing portion surrounding the optical portion, a light-adjusting component embedded in the lens body, a circuit structure disposed at the annular wearing portion, a control chip disposed at the annular wearing portion, and a light sensor disposed at the annular wearing portion. The light-adjusting component includes a first electrode layer, a second electrode layer, and a first liquid crystal layer disposed between the first electrode layer and the second electrode layer, wherein a distribution area of the light-adjusting component covers entire of the optical portion. The control chip is connected to the light-adjusting component through the circuit structure. The light sensor is connected to the control chip through the circuit structure. The control chip tunes a driving voltage being output to the light-adjusting component based on an ambient light intensity detected by the light sensor, thereby adjusting a light transmittance of the light-adjusting component.

In some embodiments, the first electrode layer and the second electrode layer are plane electrodes, and the first electrode layer and the second electrode layer are made of transparent conductive material.

In some embodiments, the smart contact lens further includes a rechargeable battery disposed at the annular wearing portion, wherein the rechargeable battery is connected to the control chip and the light sensor through the circuit structure.

In some embodiments, the lens body has a front surface and a back surface opposite to each other, the back surface is adapted to be worn on a user's eye, the back surface of the lens body is a curve surface, and a curvature of the light-adjusting component is same as a curvature of the back surface of the lens body.

In some embodiments, the lens body has a front surface and a back surface opposite to each other, the back surface is adapted to be worn on a user's eye, the back surface of the lens body is a curve surface, and the light-adjusting component is a plate structure.

In some embodiments, the light-adjusting component further includes a third electrode layer, a fourth electrode layer, a second liquid crystal layer disposed between the third electrode layer and the fourth electrode layer, a fifth electrode layer, a sixth electrode layer, and a third liquid crystal layer disposed between the fifth electrode layer and the sixth electrode layer. The first liquid crystal layer, the second liquid crystal layer, and the third liquid crystal layer are arranged in a stack, wherein the first liquid crystal layer is a cholesteric liquid crystal layer having red dye, the second liquid crystal layer is a cholesteric liquid crystal layer having green dye, and the third liquid crystal layer is a cholesteric liquid crystal layer having blue dye.

In some embodiments, the circuit structure includes a carrier and a plurality of wirings disposed on the carrier, the carrier has a plurality of slots, and the slots are disposed between the wirings.

In some embodiments, the smart contact lens further includes an air gap disposed between the light-adjusting component and the lens body.

In some embodiments, the lens body includes a pre-mold piece and an assemble piece coupled to the pre-mold piece, a material characteristic of the pre-mold piece is same as or different from a material characteristic of the assemble piece, and the light-adjusting component is embedded in the pre-mold piece.

In some embodiments, the pre-mold piece and the assemble piece are made of rigid gas permeable contact lens material, and a water content of the pre-mold piece is equal to or smaller than a water content of the assemble piece.

In some embodiments, the pre-mold piece is made of rigid gas permeable contact lens material having a hydration level less than 1.

In some embodiments, the pre-mold piece is made of rigid gas permeable contact lens material, and the assemble piece is made of soft contact lens material.

In some embodiments, the lens body has a front surface and a back surface opposite to each other, and the pre-mold piece is arranged at the front surface.

In some embodiments, the lens body has a front surface and a back surface opposite to each other, and the pre-mold piece is arranged at the back surface.

In some embodiments, the lens body has a front surface and a back surface opposite to each other, the pre-mold piece is arranged to interconnect the front surface and the back surface, and the assemble piece adjoins a peripheral of the pre-mold piece.

In some embodiments, the lens body has a front surface and a back surface opposite to each other, the assemble piece is arranged to interconnect the front surface and the back surface, the pre-mold piece is disposed in the assemble piece, wherein the assemble piece includes a plurality of through holes disposed at the front surface, and portions of a surface of the pre-mold piece are exposed by the through holes.

An aspect of the disclosure provides a smart contact lens. The smart contact lens includes a lens body including an optical portion and an annular wearing portion surrounding the optical portion, and a pattern displaying component embedded in the lens body. The optical portion includes a central region and a peripheral region surrounding the central region, and a distribution area of the pattern displaying component covers peripheral region and optionally covers the central region. The pattern displaying component includes a plurality of pixels and an electrode array configured to drive the pixels, wherein each of the pixels includes a cholesteric liquid crystal layer having red dye, a cholesteric liquid crystal layer having green dye, and a cholesteric liquid crystal layer having blue dye. The smart contact lens further includes a circuit structure disposed at the annular wearing portion, a control chip disposed at the annular wearing portion, and a transmission module disposed at the annular wearing portion. The control chip is connected to the pattern displaying component through the circuit structure. The transmission module is connected to the control chip through the circuit structure, wherein the control chip tunes driving voltages being output to the electrode array based on a pattern signal received by the transmission module, thereby changing a display pattern displayed by the pattern displaying component.

In some embodiments, in each of the pixels of the pattern displaying component, the cholesteric liquid crystal layer having red dye, the cholesteric liquid crystal layer having green dye, and the cholesteric liquid crystal layer having blue dye are arranged side by side.

In some embodiments, in each of the pixels of the pattern displaying component, the cholesteric liquid crystal layer having red dye, the cholesteric liquid crystal layer having green dye, and the cholesteric liquid crystal layer having blue dye are arranged in a stack.

In some embodiments, the smart contact lens further includes a rechargeable battery disposed at the annular wearing portion, wherein the rechargeable battery is connected to the control chip and the transmission module through the circuit structure,

In some embodiments, the lens body has a front surface and a back surface opposite to each other, the back surface is adapted to be worn on a user's eye, the back surface of the lens body is a curve surface, and a curvature of the pattern displaying component is same as a curvature of the back surface of the lens body.

In some embodiments, the lens body has a front surface and a back surface opposite to each other, the back surface is adapted to be worn on a user's eye, the back surface of the lens body is a curve surface, and the pattern displaying component is a plate structure.

In some embodiments, the circuit structure includes a carrier and a plurality of wirings disposed on the carrier, the carrier has a plurality of slots, and the slots are disposed between the wirings.

In some embodiments, the smart contact lens further includes an air gap disposed between the pattern displaying component and the lens body.

In some embodiments, the lens body includes a pre-mold piece and an assemble piece coupled to the pre-mold piece, a material characteristic of the pre-mold piece is same as or different from a material characteristic of the assemble piece, and the pattern displaying component is embedded in the pre-mold piece.

In some embodiments, the pre-mold piece and the assemble piece are made of rigid gas permeable contact lens material, and a water content of the pre-mold piece is equal to or smaller than a water content of the assemble piece.

In some embodiments, the pre-mold piece is made of rigid gas permeable contact lens material having a hydration level less than 1.

In some embodiments, the pre-mold piece is made of rigid gas permeable contact lens material, and the assemble piece is made of soft contact lens material.

In some embodiments, the lens body has a front surface and a back surface opposite to each other, and the pre-mold piece is arranged at the front surface.

In some embodiments, the lens body has a front surface and a back surface opposite to each other, and the pre-mold piece is arranged at the back surface.

In some embodiments, the lens body has a front surface and a back surface opposite to each other, the pre-mold piece is arranged to interconnect the front surface and the back surface, and the assemble piece adjoins a peripheral of the pre-mold piece.

In some embodiments, the lens body has a front surface and a back surface opposite to each other, the assemble piece is arranged to interconnect the front surface and the back surface, the pre-mold piece is disposed in the assemble piece, wherein the assemble piece includes a plurality of through holes disposed at the front surface, and portions of a surface of the pre-mold piece are exposed by the through holes.

An aspect of the disclosure provides a method of fabricating smart contact lens. The method includes forming an optical device; placing the optical device into a pre-mold piece mold; injecting a first contact lens material into the pre-mold piece mold, wherein the optical device is at least partially covered by the first contact lens material; curing the first contact lens material to obtain a pre-mold piece having the optical device therein; releasing the pre-mold piece from the pre-mold piece mold; and coupling the pre-mold piece to an assemble piece to obtain a smart contact lens, wherein the assemble piece includes a second contact lens material, and a material characteristic of the first contact lens material is same as or different from a material characteristic of the second contact lens material.

In some embodiments, the first contact lens material and the second contact lens material are rigid gas permeable contact lens material, and a water content of the first contact lens material is equal to or smaller than a water content of the second contact lens material.

In some embodiments, the first contact lens material is a rigid gas permeable contact lens material, and the second contact lens material is a soft contact lens material.

In some embodiments, the first contact lens material is a rigid gas permeable contact lens material having a hydration level less than 1.

In some embodiments, the step of coupling the pre-mold piece to the assemble piece includes placing the pre-mold piece into a contact lens mold; injecting the second contact lens material into the contact lens mold, wherein the pre-mold piece is at least partially covered by the second contact lens material; and curing the second contact lens material to form the assemble piece that is coupled to the pre-mold piece.

In some embodiments, the step of placing the pre-mold piece into the contact lens mold includes supporting the pre-mold piece with a plurality of protrusions of the contact lens mold.

In some embodiments, the step of coupling the pre-mold piece to the assemble piece includes injecting the second contact lens material into the contact lens mold; curing the second contact lens material; releasing the cured second contact lens material from the contact lens mold; machining the cured second contact lens material to obtain the assemble piece having a containing cavity; and securing the pre-mold piece in the containing cavity of the assemble piece by using an adhesive.

In some embodiments, the step of coupling the pre-mold piece to the assemble piece includes injecting the second contact lens material into an assemble piece mold; curing the second contact lens material; releasing the cured second contact lens material from the assemble piece mold to obtain the assemble piece having a containing cavity; and securing the pre-mold piece in the containing cavity of the assemble piece by using an adhesive.

In some embodiments, the step of forming the optical device includes disposing a light-adjusting component on a carrier, wherein the light-adjusting component includes a first electrode layer, a second electrode layer, and a first liquid crystal layer disposed between the first electrode layer and the second electrode layer; disposing a wiring on the carrier, wherein the light-adjusting component is surrounded by and is connected to the wiring; disposing a control chip on the carrier, wherein the control chip is connected to the light-adjusting component through the wiring; and disposing a light sensor on the carrier, wherein the light sensor is connected to the control chip through the wiring.

In some embodiments, the step of forming the optical device includes disposing a pattern displaying component on a carrier, wherein the pattern displaying component includes a plurality of pixels and an electrode array configured to drive the pixels, and each of the pixels includes a cholesteric liquid crystal layer having red dye, a cholesteric liquid crystal layer having green dye, and a cholesteric liquid crystal layer having blue dye; disposing a wiring on the carrier, wherein the pattern displaying component is surrounded by and is connected to the wiring; disposing a control chip on the carrier, wherein the control chip is connected to the pattern displaying component through the wiring; and disposing a transmission module on the carrier, wherein the transmission module is connected to the control chip through the wiring.

The present disclosure provides embodiments of smart contact lenses and methods of fabricating the same. The smart contact lens includes the light-adjusting component to provide sunglass function, or the smart contact lens includes the pattern displaying component to provide makeup function. The light-adjusting component and the pattern displaying component respectively include liquid crystal layer(s) to tune light transmittance and/or color performance which is low power consume and low thermal generation. The light-adjusting component and the pattern displaying component can be individually or integrated in the optical device, and the light transmittance and/or color performance can be tuned based on requirements thereby providing desired sunglass and pattern displaying function.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a front view of a smart contact lens according to some embodiments of the disclosure.

FIG. 2 is a cross-sectional view taken along line A-A in FIG. 1.

FIG. 3 is a cross-sectional view of some other embodiments of the smart contact lens taken along line A-A in FIG. 1.

FIG. 4A to FIG. 4C are cross-sectional views of the light-adjusting component of smart lens under different states, according to some embodiments of the disclosure.

FIG. 5 and FIG. 6 are cross-sectional views of the light-adjusting component of smart lens according to some other embodiments of the disclosure.

FIG. 7A to FIG. 7C are cross-sectional views of the light-adjusting component of smart lens under different states, according to some embodiments of the disclosure.

FIG. 8 is a front view of the smart contact lens according to some other embodiments of the disclosure.

FIG. 9 and FIG. 10 are partially explosion views of different embodiments of the pattern display component of FIG. 8.

FIG. 11A and FIG. 11B are schematic flows of a method of fabricating a smart contact lens, according to some embodiments of the disclosure.

FIG. 12 is a schematic flow of a method of fabricating a smart contact lens, according to some embodiments of the disclosure.

FIG. 13 is a schematic view of a method of fabricating the assemble piece of the smart contact lens, according to some embodiments of the disclosure.

FIG. 14 is a schematic view of a method of fabricating the assemble piece of the smart contact lens, according to some other embodiments of the disclosure.

FIG. 15 to FIG. 19 are cross-sectional views of different embodiments of the smart contact lens of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

Further, spatially relative terms, such as “on,” “over,” “under,” “between” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

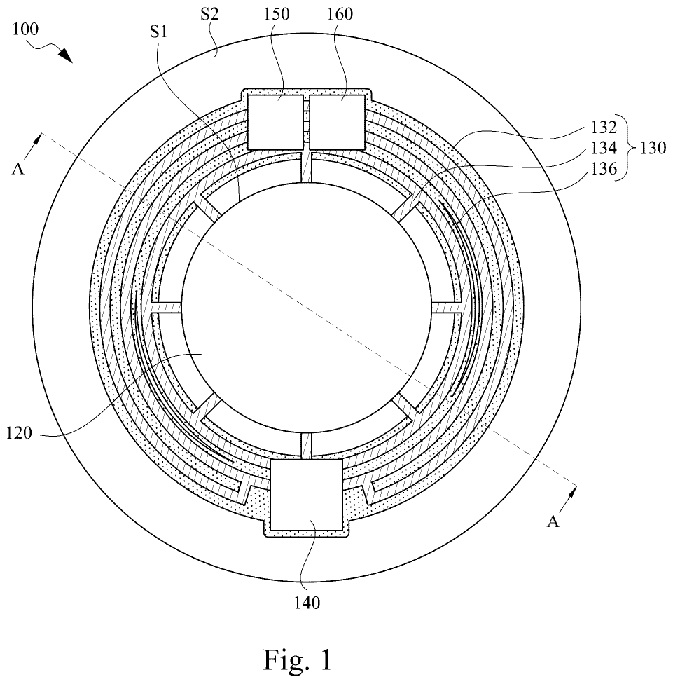

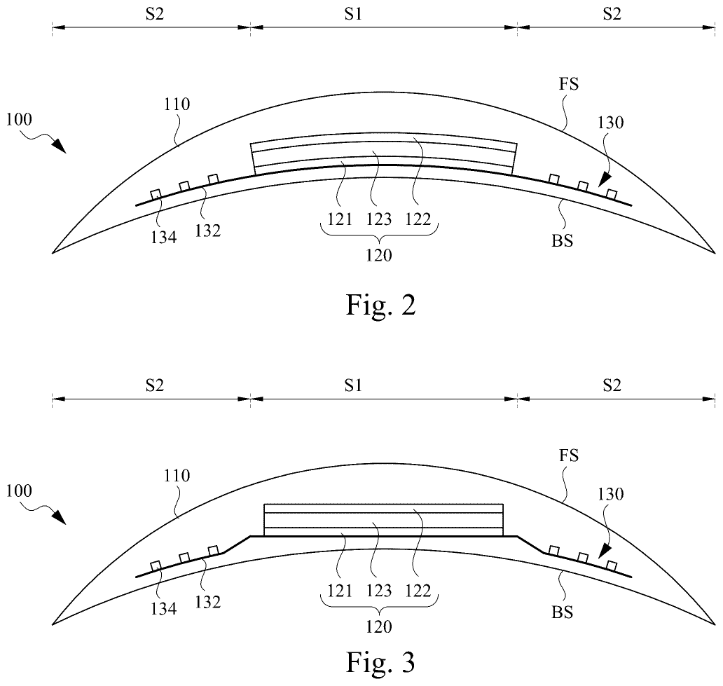

Reference is made to FIG. 1 and FIG. 2, in which FIG. 1 is a front view of a smart contact lens according to some embodiments of the disclosure, and FIG. 2 is a cross-sectional view taken along line A-A in FIG. 1. In this disclosure, the smart contact lens 100 may provide refractive error correction function, and the refractive error can be such as hyperopia, myopia, astigmatism, presbyopia, or astigmatism-presbyopia. Optionally, the smart contact lens 100 may be a makeup lens without refractive error correction function.

The smart contact lens 100 includes a lens body 110 and a light-adjusting component 120 embedded in the lens body 110. The lens body 110 includes an optical portion S1 and an annular wearing portion S2 surrounding the optical portion S1, in which the optical portion S1 corresponds to cornea when the user wears the smart contact lens 100.

The light-adjusting component 120 is embedded in the lens body 110, and a distribution area of the light-adjusting component 120 covers entire of the optical portion S1. In some embodiments, the light-adjusting component 120 includes a first electrode layer 121, a second electrode layer 122, and a first liquid crystal layer 123 disposed between the first electrode layer 121 and the second electrode layer 122. By tuning the liquid crystal molecule deflecting angle of the first liquid crystal layer 123 of the light-adjusting component 120, the light transmittance of the light-adjusting component 120 can be changed, thereby allowing the smart contact lens 100 providing sunglass function. In some embodiments, the first electrode layer 121 and the second electrode layer 122 are plane electrodes, and the first electrode layer 121 and the second electrode layer 122 are made of transparent conductive material.

The smart contact lens 100 further includes a circuit structure 130 disposed at the annular wearing portion S2, a control chip 140 disposed at the annular wearing portion S2, and a light sensor 150 disposed at the annular wearing portion S2. The control chip 140 is connected to the light-adjusting component 120 through the circuit structure 130, and the light sensor 150 is connected to the control chip 140 through the circuit structure 130, in which the control chip 140 tunes a driving voltage being output to light-adjusting component 120 based on an ambient light intensity detected by the light sensor 150, thereby tuning the liquid crystal molecule deflecting angle of the first liquid crystal layer 123 of the light-adjusting component 120, to further adjust the light transmittance of the light-adjusting component 120.

The smart contact lens 100 further includes a rechargeable battery 160 disposed at the annular wearing portion S2. The rechargeable battery 160 is connected to the control chip 140 and the light sensor 150 through the circuit structure 130, to provide the power that the control chip 140 and the light sensor 150 require. In some embodiments, the rechargeable battery 160 is coil inductive type wireless recharging module.

In some embodiments, the circuit structure 130 includes a carrier 132 and a plurality of wirings 134 disposed on the carrier 132. The carrier 132 has a plurality of slots 136, and the slots 136 are disposed between the wirings 134, to improve oxygen permeability of the smart contact lens 100.

The lens body 110 has a front surface FS and a back surface BS opposite to each other, in which the back surface BS is adapted to be worn on a user's eye. The back surface BS of the optical portion S1 of the lens body 110 is a curve surface. More particularly, the back surface BS of the optical portion S1 of the lens body 110 is an aspheric (not semi sphere). As shown in FIG. 2, a curvature of the light-adjusting component 120 can be same as a curvature of the back surface BS of the optical portion S1 of the lens body 110.

Alternatively, refer to FIG. 3, which is a cross-sectional view of some other embodiments of the smart contact lens taken along line A-A in FIG. 1. In some other embodiments, the light-adjusting component 120 is a plate structure (curvature is almost zero), and the curvature of the light-adjusting component 120 is different from a curvature of the back surface BS of the optical portion S1 of the lens body 110.

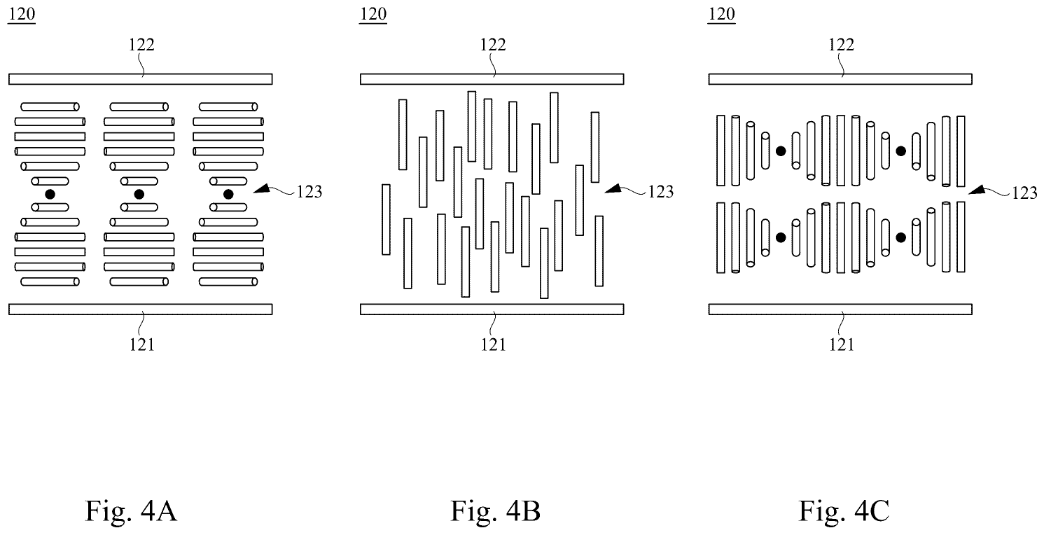

Reference is made to FIG. 4A to FIG. 4C, which are cross-sectional views of the light-adjusting component of smart lens under different states, according to some embodiments of the disclosure. The light-adjusting component 120 includes the first electrode layer 121, the second electrode layer 122, and the first liquid crystal layer 123 disposed between the first electrode layer 121 and the second electrode layer 122. The first liquid crystal layer 123 is a cholesteric liquid crystal layer. The cholesteric liquid crystal layer exhibits bistable properties, meaning they can naturally remain stable in two states. One state is the planar state as shown in FIG. 4A, where the liquid crystal molecules are aligned in an orderly manner, reflecting specific wavelengths of light, corresponds to filtering specific wavelengths state. The other state is the focal conic state as shown in FIG. 4C, where the liquid crystal molecules are arranged in a disordered manner, scattering incident light and allowing most of it to pass through. In this state, the color of the substance beneath the liquid crystal layer. Additionally, there is a temporary state known as the homeotropic state as shown in FIG. 4B, where all liquid crystal molecules are aligned perpendicularly, allowing all light to pass through.

By changing the electric field applying to the cholesteric first liquid crystal layer 123, the state of the light-adjusting component 120 can be selected from one of the planar state as shown in FIG. 4A, the homeotropic state as shown in FIG. 4B, and the focal conic state as shown in FIG. 4C. More specifically, the deflecting state of the first liquid crystal layer 123 can be changed by applying an electric field and controlling the speed of its removal, and the electric field applied on the first electrode layer 121 and the second electrode layer 122 of the light-adjusting component 120 is changed by the output driving voltage of the control chip 140 (as shown in FIG. 1), and the driving voltage of the control chip 140 is tuned based on an ambient light intensity detected by the light sensor 150 (as shown in FIG. 1).

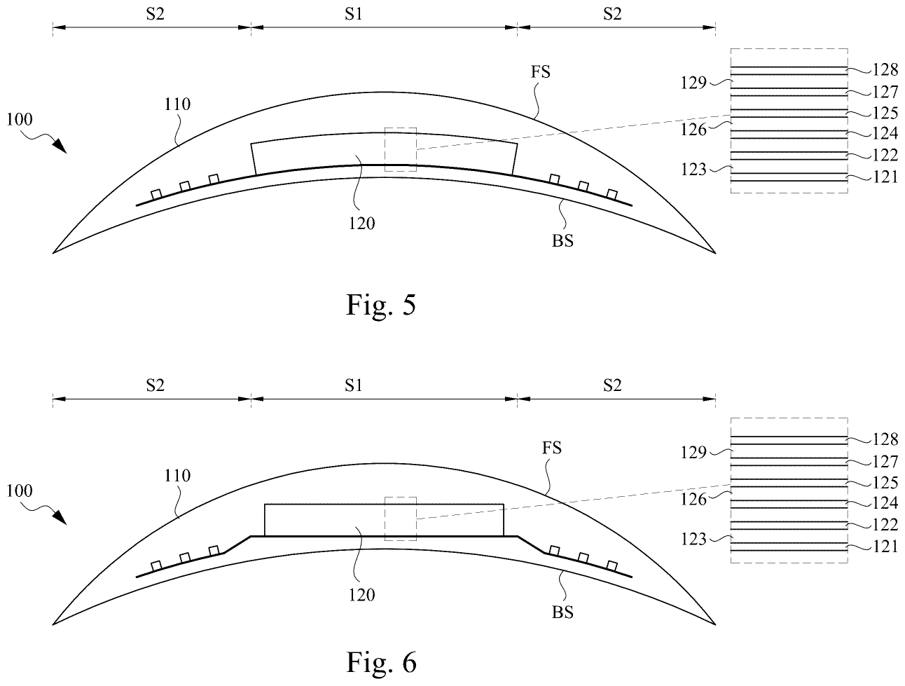

Reference is further made to FIG. 5 and FIG. 6, which are cross-sectional views of the light-adjusting component of smart lens according to some other embodiments of the disclosure, in which cross-sections of FIG. 5 and FIG. 6 are also taken along line A-A in FIG. 1. As shown in the embodiments of FIG. 5 and FIG. 6, the light-adjusting component 120 of the smart contact lens 100 provides not only light-filtering function but also color changing function. More specifically, the light-adjusting component 120 includes the first electrode layer 121, the second electrode 122, and the first liquid crystal layer 123 and further includes a third electrode layer 124, a fourth electrode layer 125, a second liquid crystal layer 126 between the third electrode layer 124 and the fourth electrode layer 125, a fifth electrode layer 127, a sixth electrode layer 128, and a third liquid crystal layer 129 between the fifth electrode layer 127 and the sixth electrode layer 128. The first liquid crystal layer 123, the second liquid crystal layer 126, and the third liquid crystal layer 129 are arranged in a stack.

The lens body 110 has the front surface FS and the back surface BS opposite to each other, the back surface BS is adapted to be worn on a user's eye. The back surface BS of the lens body 110 is a curve surface. More particularly, the back surface BS of the optical portion S1 of the lens body 110 is an aspheric (not semi sphere). As shown in FIG. 5, a curvature of the light-adjusting component 120 having three liquid crystal layers can be same as a curvature of the back surface BS of the optical portion S1 of the lens body 110. Alternatively, as shown in FIG. 6, the light-adjusting component 120 is a plate structure, and the curvature of the light-adjusting component 120 is different from a curvature of the back surface BS of the optical portion S1 of the lens body 110.

In some embodiments, because of the limited spacing of the smart contact lens 100, the conventional color performance by adjusting the pitch of the liquid crystal molecules to reflect different wavelengths is not sufficient in the smart contact lens 100. Therefore, the first liquid crystal layer 123 is a cholesteric liquid crystal layer having red dye, the second liquid crystal layer 126 is a cholesteric liquid crystal layer having green dye, and the third liquid crystal layer 129 is a cholesteric liquid crystal layer having blue dye, of the smart contact lens 100. The smart contact lens 100 can provide color change sunglass function by using dyed liquid crystal layers to absorb different wavelengths and tuning the light transmission of the dyed liquid crystal layers.

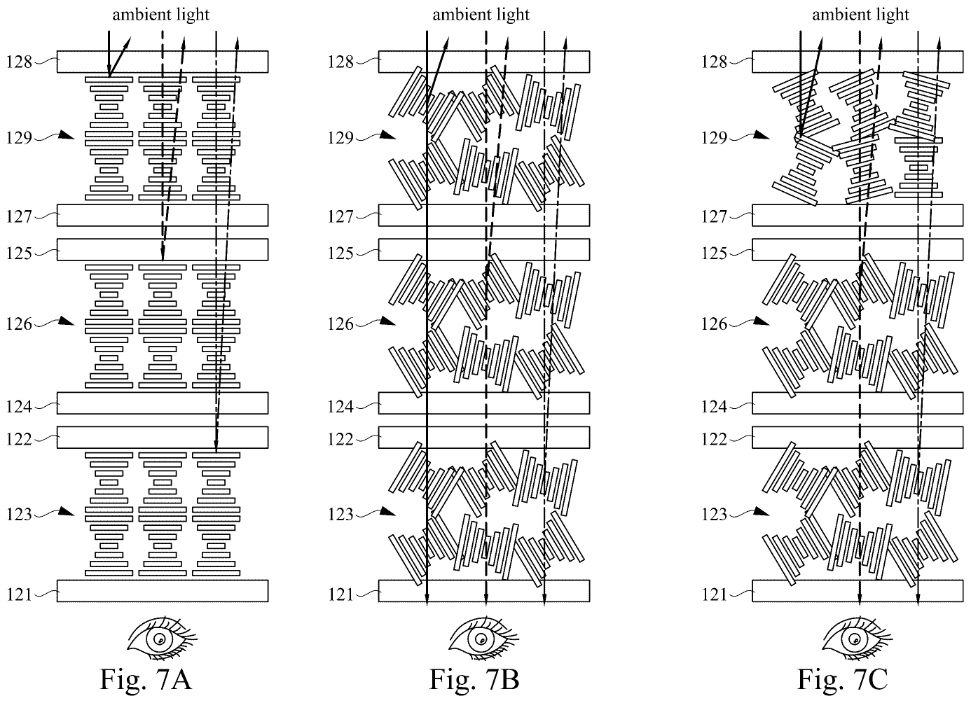

Reference is made to FIG. 7A to FIG. 7C, which are cross-sectional views of the light-adjusting component of smart lens under different states, according to some embodiments of the disclosure. As shown in FIG. 7A, when the ambient light intensity is too strong, the liquid crystal deflecting states of the first liquid crystal layer 123, the second liquid crystal layer 126, and the third liquid crystal layer 129 are all planar states. Most of red light wavelength, the green light wavelength, and the blue light wavelength are reflected at the first liquid crystal layer 123, the second liquid crystal layer 126, and the third liquid crystal layer 129, respectively. Thus the light amount enters user's eyes is greatly reduced.

As shown in FIG. 7B, when the ambient light intensity is slightly strong, the liquid crystal deflecting states of the first liquid crystal layer 123, the second liquid crystal layer 126, and the third liquid crystal layer 129 are all focal conic states. Greater parts of red light wavelength, the green light wavelength, and the blue light wavelength pass the first liquid crystal layer 123, the second liquid crystal layer 126, and the third liquid crystal layer 129, and smaller parts of red light wavelength, the green light wavelength, and the blue light wavelength are reflected by the first liquid crystal layer 123, the second liquid crystal layer 126, and the third liquid crystal layer 129, respectively. Thus light-adjusting component 120 can be regarded as semi-penetration mode (grey mode), and the light amount enters user's eyes is reduced.

Furthermore, as shown in FIG. 7C, in some particular condition such as detecting user long time using 3C product or by setting, the liquid crystal deflecting state of the third liquid crystal layer 129 is tuned such that most of blue light wavelength is reflected by the third liquid crystal layer 129, and most of red light wavelength and the green light wavelength pass the first liquid crystal layer 123, the second liquid crystal layer 126, and the third liquid crystal layer 129. Thus light-adjusting component 120 can be regarded as yellow light mode, and the blue light wavelength can be filtered.

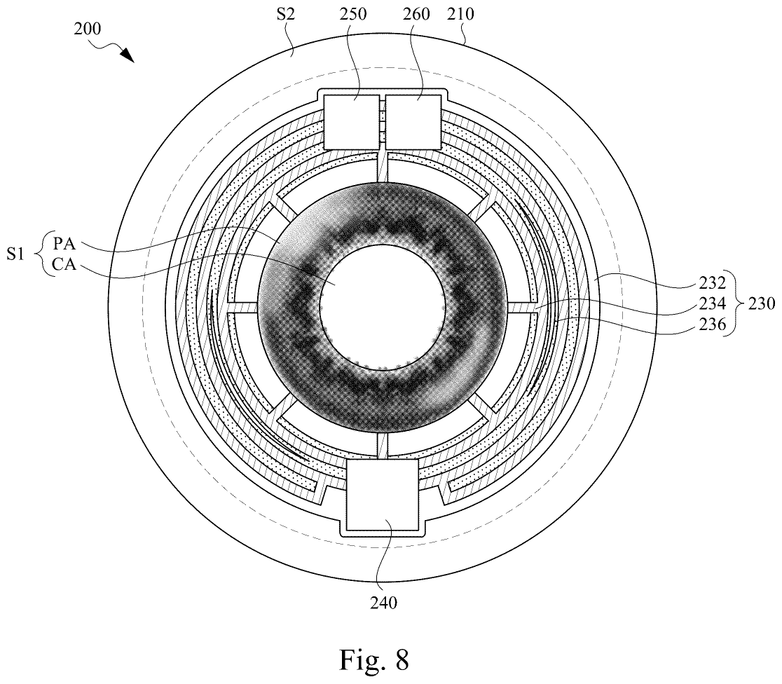

Reference is further made to FIG. 8, which is a front view of the smart contact lens according to some other embodiments of the disclosure. In some other embodiments, the smart contact lens 200 includes a lens body 210 and a pattern displaying component 220 embedded in the lens body 210. The lens body 210 includes an optical portion S1 and an annular wearing portion s2 surrounding the optical portion S1, in which the optical portion S1 corresponds to cornea when the user wears the smart contact lens 200. The optical portion S1 includes a central region CA and a peripheral region PA surrounding the central region CA. The diameter of the pattern displaying component 220 can be adjusted based on requirements and is not limited to the disclosed embodiments.

The pattern displaying component 220 is embedded in the lens body 210, and a distribution area of the pattern displaying component 220 covers entire of peripheral region PA of the optical portion S1 and optionally covers the central region CA of the optical portion S1. The pattern displaying component 220 includes a plurality of pixels, and each of the pixels can be driven individually such that the pattern displaying component 220 is able to display specific pattern, and the smart contact lens 200 provides makeup lens function. The distribution area of the pattern displaying component 220 may also optionally covers a circuit structure 230 that is disposed at the annular wearing portion S2 such that the pattern displaying component 220 is able to provide iris simulation function.

The smart contact lens 200 includes the circuit structure 230 disposed at the annular wearing portion S2, a control chip 240 disposed at the annular wearing portion S2, and a transmission module 250 disposed at the annular wearing portion S2. The control chip 240 is connected to the pattern displaying component 220 through the circuit structure 230, and the transmission module 250 is connected to the control chip 240 through the circuit structure 230. The control chip 240 tunes driving voltages being output to the pixels of the pattern displaying component 220 based on a pattern signal received by the transmission module 250, thereby changing a display pattern displayed by the pattern displaying component 220.

The smart contact lens 200 further includes a rechargeable battery 260 disposed at the annular wearing portion S2. The rechargeable battery 260 is connected to the control chip 240 and the transmission module 250 through the circuit structure 230, to provide the power that the control chip 240 and the transmission module 250 require. In some embodiments, the rechargeable battery 260 is coil inductive type wireless recharging module.

In some embodiments, the circuit structure 230 includes a carrier 232 and a plurality of wirings 234 disposed on the carrier 232. The carrier 232 has a plurality of slots 236, and the slots 236 are disposed between the wirings 234, to improve oxygen permeability of the smart contact lens 200. In some embodiments, similar to the embodiments of FIG. 2 or FIG. 3, a curvature of the pattern displaying component 220 can be same as a curvature of the back surface of the optical portion of the lens body 210, or the pattern displaying component 220 can be a plate structure.

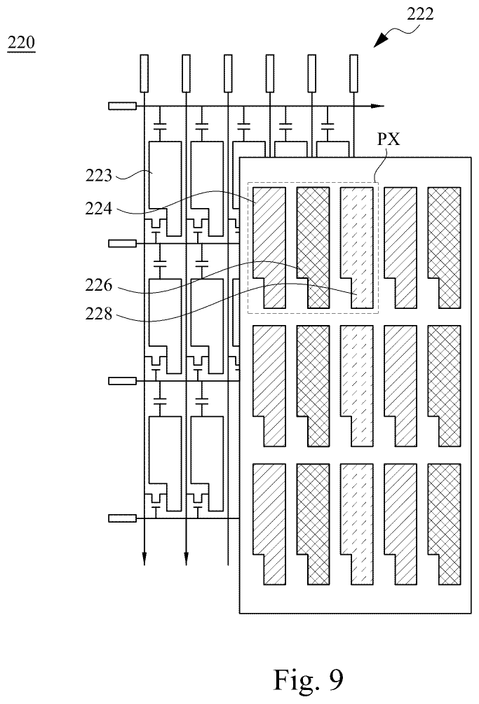

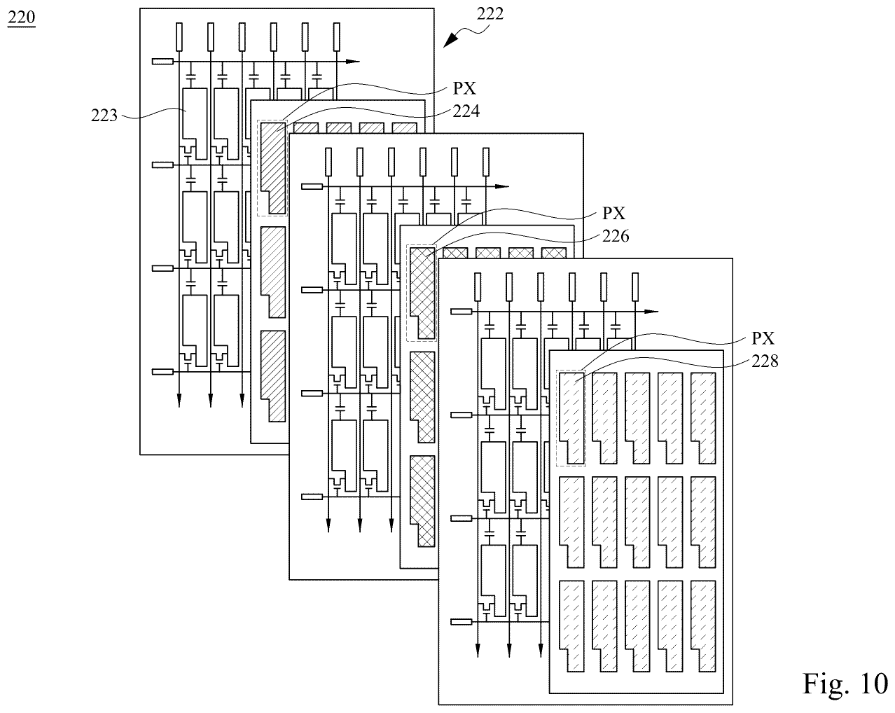

Reference is made to FIG. 9 and FIG. 10, which are partially explosion views of different embodiments of the pattern display component of FIG. 8. The pattern displaying component 220 includes a plurality of pixels PX and an electrode array 222 configured to drive the pixels PX, in which each of the pixels PX includes a cholesteric liquid crystal layer having red dye 224, a cholesteric liquid crystal layer having green dye 226, and a cholesteric liquid crystal layer having blue dye 228. The arrangement of the electrodes 223 of the electrode array 222 corresponds to the arrangement of the cholesteric liquid crystal layer having red dye 224, the cholesteric liquid crystal layer having green dye 226, and the cholesteric liquid crystal layer having blue dye 228.

More particularly, as shown in FIG. 9, in each of the pixels PX of the pattern displaying component 220, the cholesteric liquid crystal layer having red dye 224, the cholesteric liquid crystal layer having green dye 226, and the cholesteric liquid crystal layer having blue dye 228 are arranged side by side, and the corresponding electrodes 223 are also arranged side by side.

Alternatively, as shown in FIG. 10, in each of the pixels PX of the pattern displaying component 220, the cholesteric liquid crystal layer having red dye 224, the cholesteric liquid crystal layer having green dye 226, and the cholesteric liquid crystal layer having blue dye 228 are arranged in a stack, and the corresponding electrodes 223 are also arranged in a stack.

The displayed color of each of the pixels PX of the pattern displaying component 220 is determined by the liquid crystal deflecting angles of the cholesteric liquid crystal layer having red dye 224, the cholesteric liquid crystal layer having green dye 226, and/or the cholesteric liquid crystal layer having blue dye 228. By controlling the liquid crystal deflecting angle of the cholesteric liquid crystal layer, specific wavelength can be mostly reflected by or mostly passing through the cholesteric liquid crystal layer. The dye in the cholesteric liquid crystal layer can further absorb the narrow limited wavelength of the reflected specific wavelength such that the pixel PX is able to display particular color. The displayed pattern of the pattern displaying component 220 is decided by the combinations of the pixels PX's color. More particularly, the pattern signal received by the transmission module 250 of FIG. 8 can be varied, such that the control chip 240 can change the displayed pattern of the pattern displaying component 220 based on the received pattern signal by the transmission module 250.

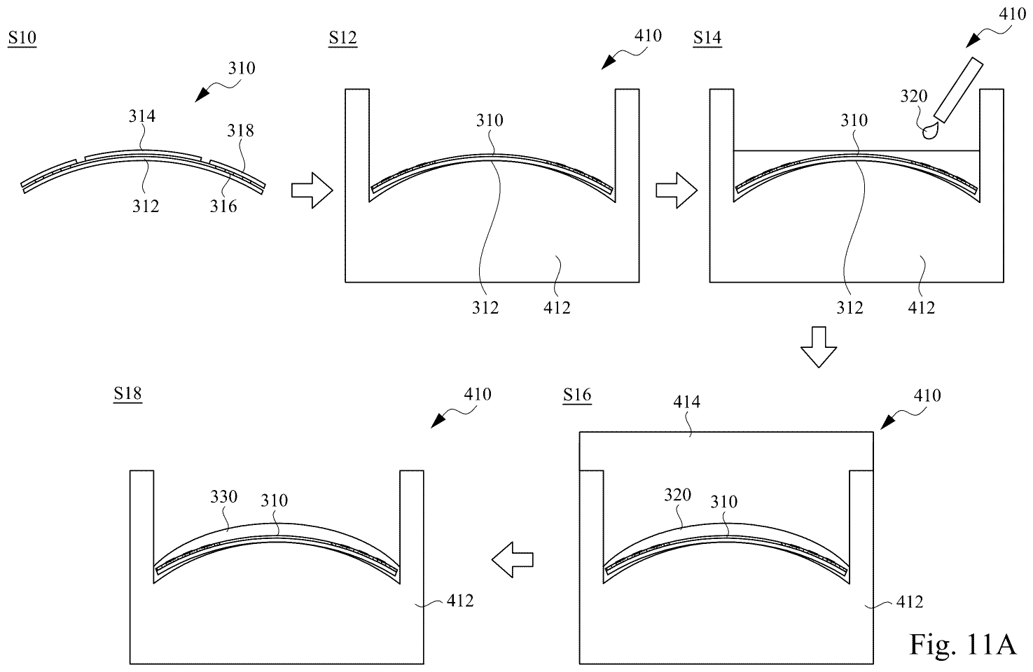

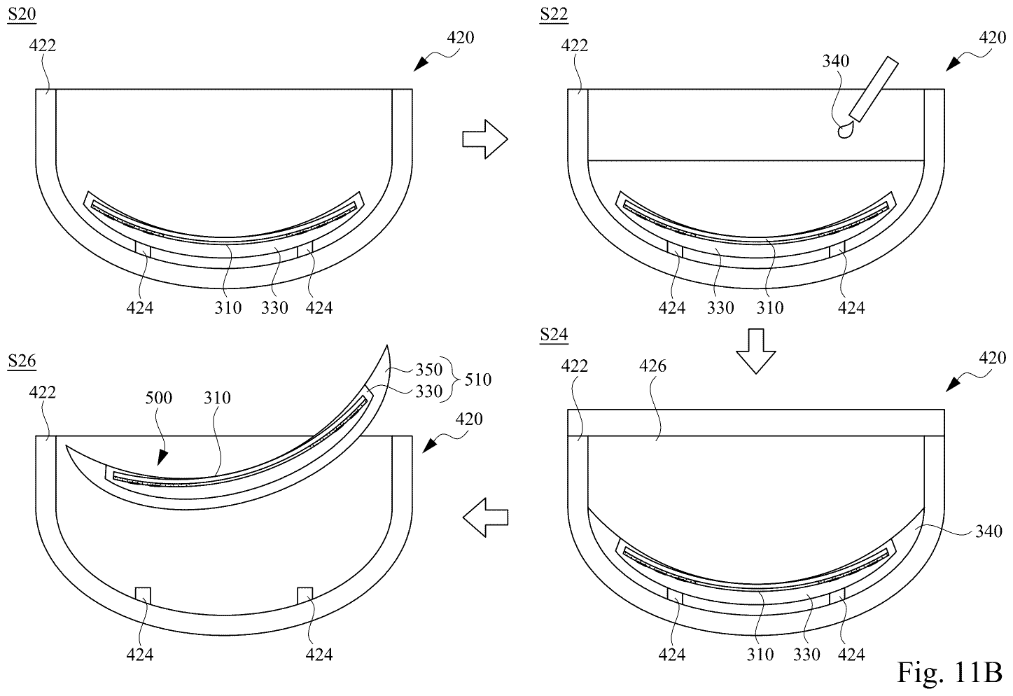

Reference is further made to FIG. 11A and FIG. 11B, which are schematic flows of a method of fabricating a smart contact lens, according to some embodiments of the disclosure. In some embodiments, the method of fabricating smart contact lens begins from step S10, including forming an optical device 310. The step S10 of forming the optical device 310 includes disposing an optical component 314 on a carrier 312, disposing wirings 316 on the carrier 312, and disposing one or more peripheral components 318 on the carrier 312. The optical component 314 can be the aforementioned light-adjusting component or pattern displaying component. The peripheral components 318 include the aforementioned control chip, light sensor, transmission module, rechargeable battery, and combinations thereof. The optical component 314 is connected to the peripheral components 318 through the wirings 316. In some embodiments, the carrier 312 may optionally include slots disposed between the wirings 316.

Then, step S12 is placing the optical device 310 into a pre-mold piece mold 410, such as placing the optical device 310 into a female mold 412 of the pre-mold piece mold 410. In some embodiments, the female mold 412 of the pre-mold piece mold 410 has a curve surface to support the optical device 310 thus the formed pre-mold piece would have a curve surface correspondingly. In some other embodiments, the female mold 412 of the pre-mold piece mold 410 has a flat surface (not shown) to support the optical device 310 thus the formed pre-mold piece would have be a plate structure surface correspondingly. In step S12, the optical device 310 is preferably in contact with the female mold 412 of the pre-mold piece mold 410 by the carrier 312.

Then, in step S14, a first contact lens material 320 is injected into the pre-mold piece mold 410, and the optical device 310 is at least partially covered by the first contact lens material 320. The first contact lens material 320 is configured to isolate the optical component 314, the wirings 316, and the peripheral components 318 from outer environment thereby preventing the optical component 314, the wirings 316, and the peripheral components 318 being damaged by moisture or oxygen. In some embodiments, the first contact lens material 320 is substantially a water-free material. For example, the first contact lens material 320 is a rigid gas permeable contact lens material having a hydration level less than 1.

Then, step S16 is performing a molding process, including pressing and coupling a male mold 414 to the female mold 412 of the pre-mold piece mold 410, and curing the first contact lens material 320. Step S18 is releasing the cured first contact lens material 320 and the optical device 310 therein from the pre-mold piece mold 410, thereby obtaining a pre-mold piece 330 having the embedded optical device 310.

Referring to FIG. 11B, step S20 is placing the pre-mold piece 330 having the embedded optical device 310 into a female mold 422 of a contact lens mold 420. In some embodiments, the shape of the pre-mold piece 330 may match or mismatch the shape of the female mold 422 of the contact lens mold 420. Namely, the shape of the pre-mold piece 330 may match the shape of the female mold 422, and a surface of the pre-mold piece 330 fitting and against the female mold 422 of the contact lens mold 420. Alternatively, the shape of the pre-mold piece 330 may mismatch the shape of the female mold 422, and a gap is present between a surface of the pre-mold piece 330 and the female mold 422 of the contact lens mold 420.

In some embodiments, the contact lens mold 420 optionally includes a plurality of protrusions 424 on the female mold 422 of the contact lens mold 420. The protrusions 424 are configured to support and position the pre-mold piece 330 in the female mold 422 of the contact lens mold 420 when the shape of the pre-mold piece 330 mismatches the shape of the female mold 422.

The method of fabricating smart contact lens goes to step S22, including injecting a second contact lens material 340 into the female mold 422 of the contact lens mold 420 such that the pre-mold piece 330 embedded with the optical device 310 is at least partially covered by the second contact lens material 340. The step S24 is performing a molding process, including coupling and pressing a male mold 426 to the female mold 422 of the contact lens mold 420, and curing the second contact lens material 340.

In some embodiments, a material characteristic of the first contact lens material 320 is same as or different from a material characteristic of the second contact lens material 340. For example, a water content of the first contact lens material 320 is equal to or smaller than a water content of the second contact lens material 340, or the first contact lens material 320 and the second contact lens material 340 are different contact lens materials. In some embodiments, the first contact lens material 320 and the second contact lens material 340 are both rigid gas permeable contact lens material, and the water content of the first contact lens material 320 is different from the water content of the second contact lens material 340. In some other embodiments, the first contact lens material 320 is a rigid gas permeable contact lens material having low water content, and the second contact lens material 340 is a soft contact lens material

In some embodiments, the second contact lens material 340 can only partially cover the pre-mold piece 330 when the shape of the male mold 426 or female mold 422 of the contact lens mold 420 match the shape of the pre-mold piece 330, and portions of the surface of the pre-mold piece 330 are exposed by the second contact lens material 340. Alternatively, the second contact lens material 340 can completely cover the pre-mold piece 330 when the shape of the male mold 426 or female mold 422 of the contact lens mold 420 mismatch the shape of the pre-mold piece 330. The cured second contact lens material 340 may also refer as an assemble piece 350, and the pre-mold piece 330 is coupled to the assemble piece 350.

Finally, step S26 is releasing the formed smart contact lens 500 from the contact lens mold 420 after curing the second contact lens material 340. The smart contact lens 500 includes a lens body 510 and the optical device 310 embedded in the lens body 510, in which the lens body 510 includes the pre-mold piece 330 and the assemble piece 350 coupled to each other. The optical device 310 is embedded in the pre-mold piece 330, and the material characteristic of the pre-mold piece 330 is same as or different from the material characteristic of the assemble piece 350.

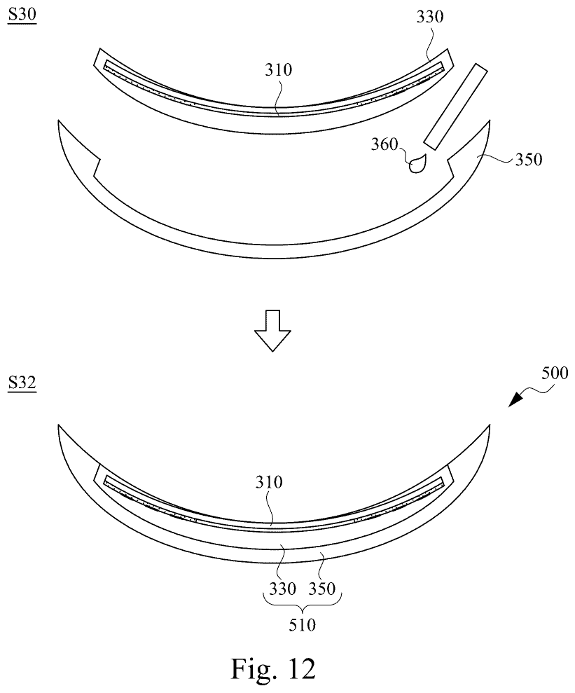

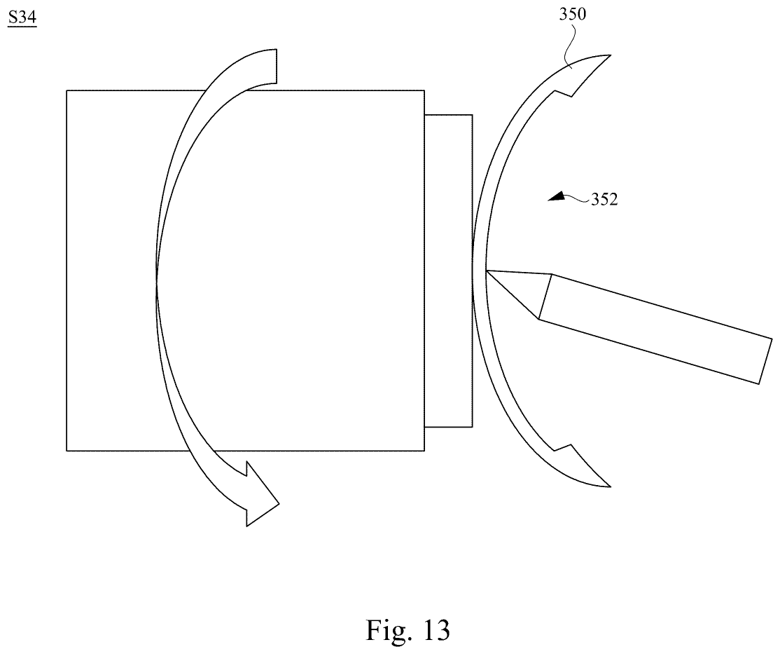

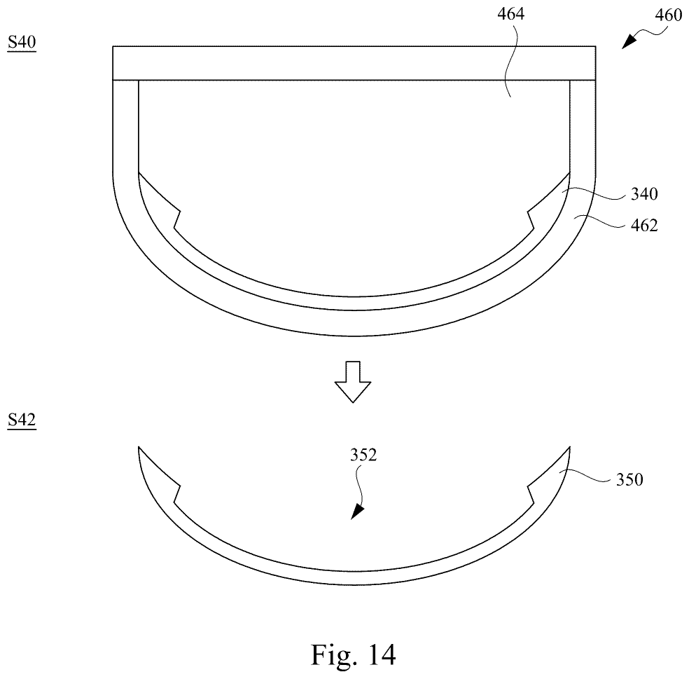

Reference is made to FIG. 12, which is a schematic flow of a method of fabricating a smart contact lens, according to some embodiments of the disclosure. In some other embodiment of a method of fabricating smart contact lens, as shown in step S30, the pre-mold piece 330 having the optical device 310 embedded therein and the assemble piece 350 can be formed individually. Then, as shown in step S32, the pre-mold piece 330 is bonded to the assemble piece 350 by using an adhesive 360, thereby obtaining the smart contact lens 500. The fabricating of the pre-mold piece 330 having the optical device 310 embedded therein may refer to step S10 to step S18 in FIG. 11A. The fabricating of the assemble piece 350 may refer FIG. 13 or FIG. 14, as following.

Reference is made to FIG. 13, which is a schematic view of a method of fabricating the assemble piece of the smart contact lens, according to some embodiments of the disclosure. The method of fabricating the assemble piece follows the steps S22 and S24 of FIG. 11B, including injecting the second contact lens material 340 into the contact lens mold 420, coupling and pressing a male mold 426 to the female mold 422 of the contact lens mold 420, and curing the second contact lens material 340. The cured second contact lens material 340 is released from the contact lens mold 420. Then, as shown in step S34, machining the cured second contact lens material 340 to obtain the assemble piece 350 having a containing cavity 352. According to some other embodiments, the assemble piece 350 having a containing cavity 352 can be fabricated by lathing a contact lens tablet made of rigid gas permeable contact lens material, referring to FIG. 13.

Alternatively, as shown in FIG. 14, which is a schematic view of a method of fabricating the assemble piece of the smart contact lens, according to some other embodiments of the disclosure. The method of fabricating the assemble piece begins from step S40, including injecting the second contact lens material 340 into an assemble piece mold 460, coupling and pressing a male mold 464 to the female mold 462 of the assemble piece mold 460, and curing the second contact lens material 340. Then, as shown in step S42, the cured second contact lens material 340 is released from the assemble piece mold 460, thereby obtaining the assemble piece 350 having the containing cavity 352.

It is noted that the shape of the containing cavity 352 of the assemble piece 350 is determined according to the final smart contact lens 500. In some embodiments, the position of the containing cavity 352 can be at the front side or back side of the lens body 510 (as shown in FIG. 12). In some embodiments, the shape of the containing cavity 352 can match or mismatch the shape of the pre-mold piece 330 (as shown in FIG. 12).

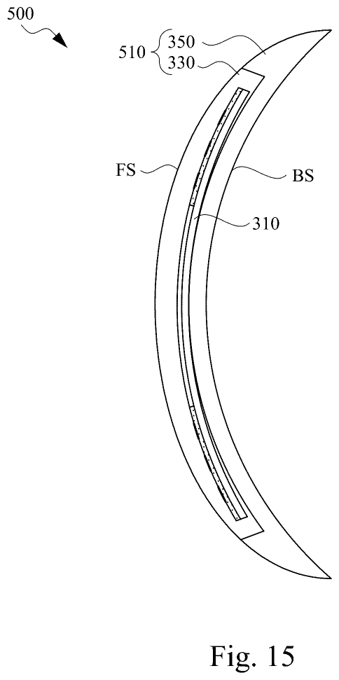

Reference is made to FIG. 15 to FIG. 19, which are cross-sectional views of different embodiments of the smart contact lens of the disclosure. The smart contact lens 500 includes the lens body 510 and the optical device 310 embedded in the lens body, in which the lens body 510 includes the pre-mold piece 330 and the assemble piece 350 coupled to each other. In some embodiments, the optical device 310 includes aforementioned light-adjusting component such that the smart contact lens 500 is able to provide sunglass function. In some embodiments, the optical device 310 includes aforementioned pattern displaying component such that the smart contact lens 500 is able to provide makeup function.

As shown in FIG. 15, the lens body 510 includes the front surface FS and the back surface BS opposite to each other. The back surface BS is adapted to be worn on a user's eye. The pre-mold piece 330 is disposed at the front surface FS and is assembled in the assemble piece 350. The extension length of the assemble piece 350 is larger than the extension length of the pre-mold piece 330. The smart contact lens 500 is in contact with user's eye with the assemble piece 350 having higher water content. The smart contact lens 500 of this embodiment can be fabricated by the method provided in FIGS. 11A and 11B or FIG. 12. The additional advantage of this embodiment is that the curvature of the back surface BS can be customized based on user's eye ball profile, to improve comfortability.

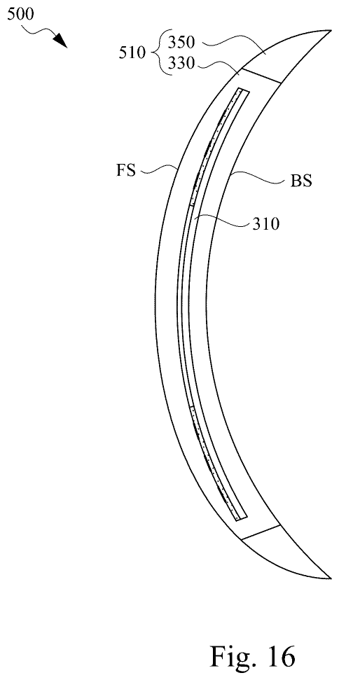

As shown in FIG. 16, the lens body 510 includes the front surface FS and the back surface BS opposite to each other. The back surface BS is adapted to be worn on a user's eye. The pre-mold piece 330 interconnects the front surface FS and the back surface BS, and the assemble piece 350 adjoins a peripheral of the pre-mold piece 330. The smart contact lens 500 is in contact with user's eye by the pre-mold piece 330 made of rigid gas permeable contact lens material. Due to the material difference or process difference, a visible interface is present between the pre-mold piece 330 and the assemble piece 350. The smart contact lens 500 of this embodiment can be fabricated by the method provided in FIGS. 11A and 11B or FIG. 12.

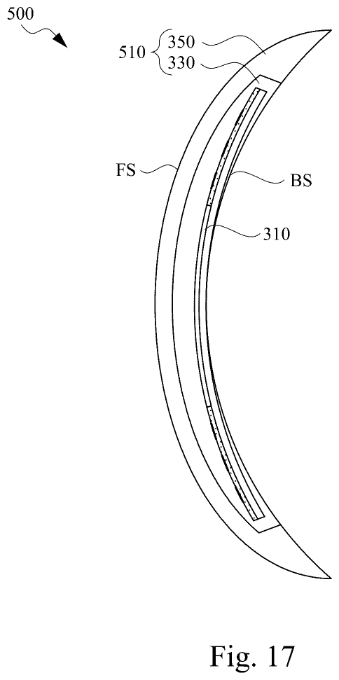

As shown in FIG. 17, the lens body 510 includes the front surface FS and the back surface BS opposite to each other. The back surface BS is adapted to be worn on a user's eye. The pre-mold piece 330 is disposed at the back surface BS and is assembled in the assemble piece 350. The extension length of the assemble piece 350 is larger than the extension length of the pre-mold piece 330. The smart contact lens 500 is in contact with user's eye with the pre-mold piece 330 made of rigid gas permeable contact lens material. The smart contact lens 500 of this embodiment can be fabricated by the method provided in FIGS. 11A and 11B or FIG. 12.

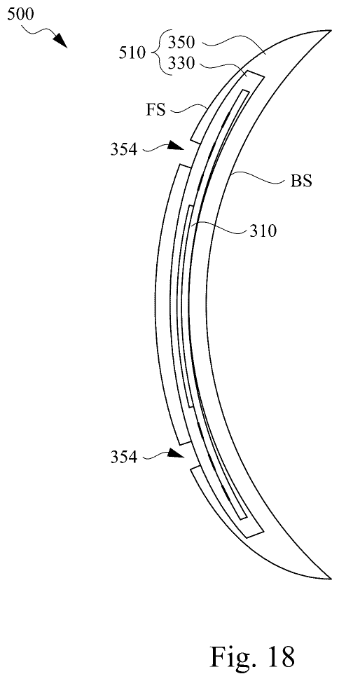

As shown in FIG. 18, the lens body 510 includes the front surface FS and the back surface BS opposite to each other. The back surface BS is adapted to be worn on a user's eye. The pre-mold piece 330 interconnects the front surface FS and the back surface BS, and the pre-mold piece 330 is assembled in the assemble piece 350. The extension length of the assemble piece 350 is larger than the extension length of the pre-mold piece 330. The smart contact lens 500 of this embodiment can be fabricated by the method provided in FIGS. 11A and 11B. Additionally, the pre-mold piece 330 is supported by the protrusions 424 in the contact lens mold 420 (as shown in FIG. 11B), the assemble piece 350 includes a plurality of through holes 354 disposed at the front surface FS, and portions of the pre-mold piece 330 are exposed by the through holes 354. On the contrary, the assemble piece 350 at the back surface BS is formed without any through hole, because the back surface BS is the surface of smart contact lens 500 that contacts user's eye.

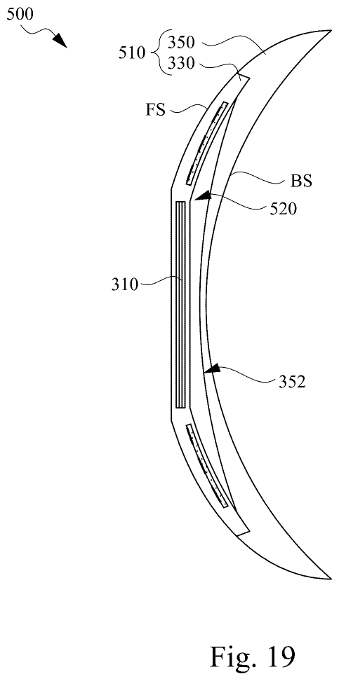

As shown in FIG. 19, the lens body 510 includes the front surface FS and the back surface BS opposite to each other. The back surface BS is adapted to be worn on a user's eye. The pre-mold piece 330 is disposed at the front surface FS and is contained in the containing cavity 352 of the assemble piece 350. The smart contact lens 500 further includes an air gap 520 disposed between the optical device 310 and the lens body 510 such as between the pre-mold piece 330 and the assemble piece 350. The air gap 520 may improve the oxygen permeability of the smart contact lens 500. The smart contact lens 500 of this embodiment can be fabricated by the method provided in FIG. 12, and the shape of the containing cavity 352 of the assemble piece 350 is different from the shape of the pre-mold piece to provide sufficient space for the air gap 520.

In conclusion, the present disclosure provides embodiments of smart contact lenses and methods of fabricating the same. The smart contact lens includes the light-adjusting component to provide sunglass function, or the smart contact lens includes the pattern displaying component to provide makeup function. The light-adjusting component and the pattern displaying component respectively include liquid crystal layer(s) to tune light transmittance and/or color performance which is low power consume and low thermal generation. The light-adjusting component and the pattern displaying component can be individually or integrated in the optical device.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A smart contact lens comprising:
a lens body comprising an optical portion and an annular wearing portion surrounding the optical portion;
a light-adjusting component embedded in the lens body, the light-adjusting component comprising a first electrode layer, a second electrode layer, and a first liquid crystal layer disposed between the first electrode layer and the second electrode layer, wherein a distribution area of the light-adjusting component covers entire of the optical portion;
a circuit structure disposed at the annular wearing portion;
a control chip disposed at the annular wearing portion, wherein the control chip is connected to the light-adjusting component through the circuit structure; and
a light sensor disposed at the annular wearing portion, wherein the light sensor is connected to the control chip through the circuit structure, wherein the control chip tunes a driving voltage being output to the light-adjusting component based on an ambient light intensity detected by the light sensor, thereby adjusting a light transmittance of the light-adjusting component.

2. The smart contact lens of claim 1, wherein the first electrode layer and the second electrode layer are plane electrodes, and the first electrode layer and the second electrode layer are made of transparent conductive material.

3. The smart contact lens of claim 1, further comprising a rechargeable battery disposed at the annular wearing portion, wherein the rechargeable battery is connected to the control chip and the light sensor through the circuit structure.

4. The smart contact lens of claim 1, wherein the lens body has a front surface and a back surface opposite to each other, the back surface is adapted to be worn on a user's eye, the back surface of the lens body is a curve surface, and a curvature of the light-adjusting component is same as a curvature of the back surface of the lens body.

5. The smart contact lens of claim 1, wherein the lens body has a front surface and a back surface opposite to each other, the back surface is adapted to be worn on a user's eye, the back surface of the lens body is a curve surface, and the light-adjusting component is a plate structure.

6. The smart contact lens of claim 1, wherein the light-adjusting component further comprises:
a third electrode layer;
a fourth electrode layer;
a second liquid crystal layer disposed between the third electrode layer and the fourth electrode layer;
a fifth electrode layer;
a sixth electrode layer; and
a third liquid crystal layer disposed between the fifth electrode layer and the sixth electrode layer, wherein the first liquid crystal layer, the second liquid crystal layer, and the third liquid crystal layer are arranged in a stack, wherein the first liquid crystal layer is a cholesteric liquid crystal layer having red dye, the second liquid crystal layer is a cholesteric liquid crystal layer having green dye, and the third liquid crystal layer is a cholesteric liquid crystal layer having blue dye.

7. The smart contact lens of claim 1, wherein the circuit structure comprises a carrier and a plurality of wirings disposed on the carrier, the carrier has a plurality of slots, and the slots are disposed between the wirings.

8. The smart contact lens of claim 1, further comprising an air gap disposed between the light-adjusting component and the lens body.

9. The smart contact lens of claim 1, wherein the lens body comprises a pre-mold piece and an assemble piece coupled to the pre-mold piece, a material characteristic of the pre-mold piece is same as or different from a material characteristic of the assemble piece, and the light-adjusting component is embedded in the pre-mold piece.

10. The smart contact lens of claim 9, wherein the pre-mold piece and the assemble piece are made of rigid gas permeable contact lens material, and a water content of the pre-mold piece is equal to or smaller than a water content of the assemble piece.

11. The smart contact lens of claim 9, wherein the pre-mold piece is made of rigid gas permeable contact lens material having a hydration level less than 1.

12. The smart contact lens of claim 9, wherein the pre-mold piece is made of rigid gas permeable contact lens material, and the assemble piece is made of soft contact lens material.

13. The smart contact lens of claim 9, wherein the lens body has a front surface and a back surface opposite to each other, and the pre-mold piece is arranged at the front surface.

14. The smart contact lens of claim 9, wherein the lens body has a front surface and a back surface opposite to each other, and the pre-mold piece is arranged at the back surface.

15. The smart contact lens of claim 9, wherein the lens body has a front surface and a back surface opposite to each other, the pre-mold piece is arranged to interconnect the front surface and the back surface, and the assemble piece adjoins a peripheral of the pre-mold piece.

16. The smart contact lens of claim 9, wherein the lens body has a front surface and a back surface opposite to each other, the assemble piece is arranged to interconnect the front surface and the back surface, the pre-mold piece is disposed in the assemble piece, wherein the assemble piece comprises a plurality of through holes disposed at the front surface, and portions of a surface of the pre-mold piece are exposed by the through holes.

17. A smart contact lens comprising:
a lens body comprising an optical portion and an annular wearing portion surrounding the optical portion, wherein the optical portion comprises a central region and a peripheral region surrounding the central region;
a pattern displaying component embedded in the lens body, wherein a distribution area of the pattern displaying component covers peripheral region and optionally covers the central region, the pattern displaying component comprises a plurality of pixels and an electrode array configured to drive the pixels, wherein each of the pixels comprises a cholesteric liquid crystal layer having red dye, a cholesteric liquid crystal layer having green dye, and a cholesteric liquid crystal layer having blue dye;
a circuit structure disposed at the annular wearing portion;
a control chip disposed at the annular wearing portion, wherein the control chip is connected to the pattern displaying component through the circuit structure; and
a transmission module disposed at the annular wearing portion, wherein the transmission module is connected to the control chip through the circuit structure, wherein the control chip tunes driving voltages being output to the electrode array based on a pattern signal received by the transmission module, thereby changing a display pattern displayed by the pattern displaying component.

18. The smart contact lens of claim 17, wherein in each of the pixels of the pattern displaying component, the cholesteric liquid crystal layer having red dye, the cholesteric liquid crystal layer having green dye, and the cholesteric liquid crystal layer having blue dye are arranged side by side.

19. The smart contact lens of claim 17, wherein in each of the pixels of the pattern displaying component, the cholesteric liquid crystal layer having red dye, the cholesteric liquid crystal layer having green dye, and the cholesteric liquid crystal layer having blue dye are arranged in a stack.

20. The smart contact lens of claim 17, further comprising a rechargeable battery disposed at the annular wearing portion, wherein the rechargeable battery is connected to the control chip and the transmission module through the circuit structure.

21. The smart contact lens of claim 17, wherein the lens body has a front surface and a back surface opposite to each other, the back surface is adapted to be worn on a user's eye, the back surface of the lens body is a curve surface, and a curvature of the pattern displaying component is same as a curvature of the back surface of the lens body.

22. The smart contact lens of claim 17, wherein the lens body has a front surface and a back surface opposite to each other, the back surface is adapted to be worn on a user's eye, the back surface of the lens body is a curve surface, and the pattern displaying component is a plate structure.

23. The smart contact lens of claim 17, wherein the circuit structure comprises a carrier and a plurality of wirings disposed on the carrier, the carrier has a plurality of slots, and the slots are disposed between the wirings.

24. The smart contact lens of claim 17, further comprising an air gap disposed between the pattern displaying component and the lens body.

25. The smart contact lens of claim 17, wherein the lens body comprises a pre-mold piece and an assemble piece coupled to the pre-mold piece, a material characteristic of the pre-mold piece is same as or different from a material characteristic of the assemble piece, and the pattern displaying component is embedded in the pre-mold piece.

26. The smart contact lens of claim 25, wherein the pre-mold piece and the assemble piece are made of rigid gas permeable contact lens material, and a water content of the pre-mold piece is equal to or smaller than a water content of the assemble piece.

27. The smart contact lens of claim 25, wherein the pre-mold piece is made of rigid gas permeable contact lens material having a hydration level less than 1.

28. The smart contact lens of claim 25, wherein the pre-mold piece is made of rigid gas permeable contact lens material, and the assemble piece is made of soft contact lens material.

29. The smart contact lens of claim 25, wherein the lens body has a front surface and a back surface opposite to each other, and the pre-mold piece is arranged at the front surface.

30. The smart contact lens of claim 25, wherein the lens body has a front surface and a back surface opposite to each other, and the pre-mold piece is arranged at the back surface.

31. The smart contact lens of claim 25, wherein the lens body has a front surface and a back surface opposite to each other, the pre-mold piece is arranged to interconnect the front surface and the back surface, and the assemble piece adjoins a peripheral of the pre-mold piece.

32. The smart contact lens of claim 25, wherein the lens body has a front surface and a back surface opposite to each other, the assemble piece is arranged to interconnect the front surface and the back surface, the pre-mold piece is disposed in the assemble piece, wherein the assemble piece comprises a plurality of through holes disposed at the front surface, and portions of a surface of the pre-mold piece are exposed by the through holes.

33. A method of fabricating smart contact lens, the method comprising;
forming an optical device;
placing the optical device into a pre-mold piece mold;
injecting a first contact lens material into the pre-mold piece mold, wherein the optical device is at least partially covered by the first contact lens material;
curing the first contact lens material to obtain a pre-mold piece having the optical device therein;
releasing the pre-mold piece from the pre-mold piece mold; and
coupling the pre-mold piece to an assemble piece to obtain a smart contact lens, wherein the assemble piece comprises a second contact lens material, and a material characteristic of the first contact lens material is same as or different from a material characteristic of the second contact lens material.

34. The method of fabricating smart contact lens of claim 33, wherein the first contact lens material and the second contact lens material are rigid gas permeable contact lens material, and a water content of the first contact lens material is equal to or smaller than a water content of the second contact lens material.

35. The method of fabricating smart contact lens of claim 33, wherein the first contact lens material is a rigid gas permeable contact lens material, and the second contact lens material is a soft contact lens material.

36. The method of fabricating smart contact lens of claim 33, wherein the first contact lens material is a rigid gas permeable contact lens material having a hydration level less than 1.

37. The method of fabricating smart contact lens of claim 33, wherein the step of coupling the pre-mold piece to the assemble piece comprises:
placing the pre-mold piece into a contact lens mold;
injecting the second contact lens material into the contact lens mold, wherein the pre-mold piece is at least partially covered by the second contact lens material; and
curing the second contact lens material to form the assemble piece that is coupled to the pre-mold piece.

38. The method of fabricating smart contact lens of claim 37, wherein the step of placing the pre-mold piece into the contact lens mold comprises:
supporting the pre-mold piece with a plurality of protrusions of the contact lens mold.

39. The method of fabricating smart contact lens of claim 33, wherein the step of coupling the pre-mold piece to the assemble piece comprises:
injecting the second contact lens material into a contact lens mold;
curing the second contact lens material;
releasing the cured second contact lens material from the contact lens mold;
machining the cured second contact lens material to obtain the assemble piece having a containing cavity; and
securing the pre-mold piece in the containing cavity of the assemble piece by using an adhesive.

40. The method of fabricating smart contact lens of claim 33, wherein the step of coupling the pre-mold piece to the assemble piece comprises:
injecting the second contact lens material into an assemble piece mold;
curing the second contact lens material;
releasing the cured second contact lens material from the assemble piece mold to obtain the assemble piece having a containing cavity; and
securing the pre-mold piece in the containing cavity of the assemble piece by using an adhesive.

41. The method of fabricating smart contact lens of claim 33, wherein the step of forming the optical device comprises:
disposing a light-adjusting component on a carrier, wherein the light-adjusting component comprises a first electrode layer, a second electrode layer, and a first liquid crystal layer disposed between the first electrode layer and the second electrode layer;
disposing a wiring on the carrier, wherein the light-adjusting component is surrounded by and is connected to the wiring;
disposing a control chip on the carrier, wherein the control chip is connected to the light-adjusting component through the wiring; and
disposing a light sensor on the carrier, wherein the light sensor is connected to the control chip through the wiring.

42. The method of fabricating smart contact lens of claim 33, wherein the step of forming the optical device comprises:
disposing a pattern displaying component on a carrier, wherein the pattern displaying component comprises a plurality of pixels and an electrode array configured to drive the pixels, and each of the pixels comprises a cholesteric liquid crystal layer having red dye, a cholesteric liquid crystal layer having green dye, and a cholesteric liquid crystal layer having blue dye;
disposing a wiring on the carrier, wherein the pattern displaying component is surrounded by and is connected to the wiring;
disposing a control chip on the carrier, wherein the control chip is connected to the pattern displaying component through the wiring; and
disposing a transmission module on the carrier, wherein the transmission module is connected to the control chip through the wiring.
